(19) United States
(12) Patent Application Publication
(10) Pub. No.: US 2005/0129952 A1
(43) Pub. Date: Jun. 16, 2005

(54) High density adsorbent structures

(75) Inventors: James A. Sawada, Vancouver (CA); Soheil Alizadeh-Khiavi, Burnaby (CA); Surajit Roy, Burnaby (CA); Steven M. Kuznicki, Edmonton (CA)

Correspondence Address: KLARQUIST SPARKMAN, LLP, 121 SW SALMON STREET, SUITE 1600, PORTLAND, OR, 97204, US

(73) Assignee: QuestAir Technologies Inc.

(21) Appl. No.: 10/954,251

(22) Filed: Sep. 29, 2004

Related U.S. Application Data
(60) Provisional application No. 60/507,151, filed on Sep. 29, 2003.

(51) Int. Cl. B32B 33/00

(52) U.S. Cl. 428/409

(57) ABSTRACT

High density adsorbent structures may be constructed in parallel passage contactor configurations using improved high density adsorbent sheets. Improved high density adsorbent sheets may be formed using adsorptively active support or substrate materials upon which adsorbent material is applied, such as by coating processes, so that in the resulting high density adsorbent structure both the substrate and the coated adsorbent material are active in adsorption processes. Alternatively, improved high density adsorbent sheets may be formed comprising precursor materials, such as certain clays, which may be coated onto known support materials and thereafter converted to active adsorbent materials using known conversion techniques. This produces high-density adsorbent sheets comprising adsorbent material without inert binder material fractions. Improved self-supporting adsorbent sheets also may be formed without using support material, resulting in higher adsorbent densities relative to known adsorbent sheets.

### CROSS REFERENCE TO RELATED APPLICATIONS

This application claims the benefit of the earlier filing date of U.S. Provisional Application No. 60/507,151, filed on Sep. 29, 2003. The entire disclosure of provisional application Ser. No. 60/507,151 is considered to be part of the disclosure of the accompanying application and is incorporated herein by reference.

### FIELD

This application relates to adsorbent structures for uses including adsorption and/or catalysis applications, and more specifically to adsorbent structures having a high density. This application also is related to Applicant's copending U.S. application Ser. No. 09/839,381 and 10/041,536, the contents of which are incorporated herein by reference.

### BACKGROUND

The use of multi-layer, laminated adsorbent structures for gas purification has been disclosed in the art, such as in Applicant's granted U.S. Pat. No. 5,082,473. Thin laminated adsorbent sheet structures have been described in the art, such as in Applicant's copending patent applications identified above, that demonstrate using web coating methods to fabricate slurried adsorbent mixtures on suitable support materials. The laminate adsorbent sheet produced by the previously disclosed methods is limited in the density of adsorbent material achievable in the laminate as a result of several factors, including the volume of the slurry binder material (to glue the particles of adsorbent powder together) and the support material, which occupy a portion of the total volume of the laminate sheet. The fraction of the laminate sheet volume occupied by these non-adsorbent material, such as binder and/or support material, reduces the amount of active adsorbent held within the total laminate sheet volume.

Adsorbent structures have been reported that demonstrate the preparation of zeolite foams. Zeolite foam structures could potentially increase the density of adsorbent material present in a given structural volume when compared to structures incorporating additional support material. Adsorbent foam materials are not suitable for use in several desirable adsorption processes, such as pressure swing adsorption (PSA), and particularly rapid cycle PSA, due to several factors, including the tortuosity of pore passages in the foam, and high void space fractions.

Monolith structures known in the art may be formed by extruding a zeolite slurry through a die but the fabrication of such structures does not allow for independent control of channel width and wall thickness. As a result, the void space in such extruded structures is undesirably high (to achieve a narrow wall thickness) or the wall thickness is undesirably thick (to achieve a narrow channel height) for use in some important adsorption processes such as PSA, and more particularly rapid cycle PSA (processes involving, for example, more than 5 cycles per minute).

Adsorbent sheets have been reported that are fabricated according to conventional paper-making techniques using discrete fibers of support materials incorporated in a slurry that also comprises binder and adsorbent materials. However, the support materials and binders serve to dilute the amount of adsorbent held within a sheet volume. A preferred method of packaging such sheets is to form them into corrugated layers. Forming corrugated sheets is not an appropriate method for preparing multi-layer adsorbent structures usable for rapid cycle PSA. Folding the corrugations in such adsorbent paper is not amenable to making extremely thin, uniform layers of material with equally narrow and uniform flow passages between material layers, as are required for optimal functioning of some desired intensive adsorption processes, such as rapid cycle PSA.

Advances in beaded adsorbent fabrication have demonstrated that binderless pellets can be made through a process of converting the binder system to active zeolite adsorbent. The chemistry behind this treatment is known in the art and several zeolites can be synthesized via various routes. Adsorbent beads treated in this manner have a higher adsorbent density than conventional beads. This is because the volume of the particle has not changed while the amount of adsorbent held within the particle has increased. However, separation process that use adsorbent pellets or beads in packed adsorbent beds are known to be limited by factors, such as fluidization, fluid friction, and specific surface area, and therefore are not suitable for optimizating some desirable adsorption processes, including rapid-cycle PSA.

### SUMMARY

Higher density adsorbent structures have a beneficial effect on many adsorption processes, including cyclic adsorption/desorption processes such as temperature swing adsorption (TSA), PSA and partial pressure swing adsorption (PPSA) processes. Higher density adsorbent structures also allow for better performance of the adsorptive process relative to processes that use adsorbent structures having lesser adsorbent densities. In the case of gas adsorption, and more particularly PSA, this performance increase is realized by processing a larger amount of gas in a smaller vessel (improved productivity) and increased intrinsic adsorptive separation capacity, which may be characterized by the reduction in the effective height of equivalent theoretical plate (HETP) value that the adsorber bed achieves. These measures of adsorptive performance are improved in the high density adsorbent structures according to the present invention by having a greater amount of active adsorbent per unit volume of the structure, or bed, which contributes to improved adsorptive recovery.

Parallel channel laminated adsorbent structures have been reported for use in adsorptive gas separation processes such as TSA, PSA and PPSA. Such laminated structures have several benefits over conventional beaded or pellet adsorbent systems which include: an ability to control the voidage of the parallel channel adsorber element by independently controlling the sheet thickness and channel spacing; faster adsorption kinetics (which may be increased by up to two to three orders of magnitude) of the adsorbent sheets compared to beaded adsorbents; and the ability to influence thermal properties of the adsorbent structure during adsorption and desorption by selecting substrate or support materials having desired thermal properties.

As with conventional beaded bed systems, the productivity and recovery from a PSA process using a parallel passage structure is strongly dependent on the density of the adsorbent in the adsorber element or bed. In the case of a structured adsorbent element comprising adsorbent material in adsorbent sheet form, the density of the adsorbent in the adsorber element is a function of the density of the adsorbent in the sheet and the voidage created by the spacer or channel used to provide gas flow channels. Once a suitable spacer has been chosen the only means to increase the density of the adsorbent in a layered parallel passage adsorber element is to increase the density of the adsorbent in the particle, wall, sheet, or layer.

The benefits of known beaded adsorbent fabrication cannot be utilized in the previously disclosed parallel passage monolith because the process of producing high density adsorbent particles is specific to relatively low aspect ratio particles, such as adsorbent pellets or beads. When the binder in known beaded or pellet adsorbents is converted, the beads or pellets are packed into a column and the required caustic solution is flowed through the bed to conduct the conversion of binder to adsorbent material. Packed bed conversion processes and the physical and chemical conditions utilized in such processes are not suitable for increasing adsorbent density in thin layered structures for several reasons, including the brittleness of the resulting adsorbent material once the binder has been converted. Brittle adsorbent materials make handling problematic and generally preclude the ability to manipulate such materials converted by such known packed bed processes in a thin sheet configuration for the fabrication of multilayer parallel-passage adsorber structures. An aspect of at least some embodiments of the present invention is to provide a high-density, thin sheet adsorbent structure, and to provide methods for fabricating such high density adsorbent sheet structures to realize the inventive benefits of parallel channel adsorber structures incorporating high density adsorbent sheet materials.

A high density adsorbent sheet according to the present invention may be prepared by increasing the adsorbent material density in the inventive sheet structure through modifying the components in the inventive sheet which detract from the adsorbent density of the sheet structure as a whole; specifically the binder system and any substrate or support upon which the adsorbent is supported. A high-density adsorbent sheet according to the present invention may include an adsorbent material suitable for a selected adsorptive separation process. Such suitable adsorbents may include, but are not limited to zeolites, activated carbons, carbon molecular sieves, alumina-based adsorbents, silica-based adsorbents, titanosilicate molecular sieves, and ceria-based molecular sieves.

In an exemplary embodiment of the present invention that incorporates activated carbon adsorbents, a high-density sheet is provided that may be fabricated by coating activated carbon powder onto fabric, cloth, or felt made from activated carbon fibers. In this configuration the substrate itself is an active adsorbent material and may increase the adsorbent density of the sheet compared to the same system using an inert or non-adsorbent support. By using an organic binder system, an activated carbon-coated activated carbon fabric, cloth, or felt may be treated under the appropriate conditions (including high temperature pyrolysis and a steam- or CO₂-activation stage) to convert the binder to active adsorbent. Using either or both of the above inventive modifications, the resulting adsorbent sheet according to the present invention possesses a high adsorbent density because a greater portion of the sheet structure may actively adsorb gases compared to systems where the binder and/or substrate are inert toward the desired adsorption process. Further inventive modifications to the above embodiment may be realized by incorporating other known adsorbent materials coated on the above referenced activated carbon fabric, cloth or felt substrate materials. Such other known adsorbents may comprise zeolites, carbon molecular sieves, alumina-based adsorbents, silica-based adsorbents, titanosilicate molecular sieves, and ceria-based molecular sieves.

In another embodiment of the present invention, an alternative method may be used to produce a similar inventive adsorbent sheet to that disclosed above. This method involves coating a carbon-fiber substrate material with activated carbon powder bound using an organic or inorganic binder. The coated sheets are exposed to water or CO₂ at elevated temperatures to convert the carbon fibers to activated carbon, i.e., carbon particles containing an internal micropore structure suitable for gas adsorption.

According to an embodiment of the present invention, an adsorbent sheet system is provided where the substrate is adsorptively active and has a different gas adsorption selectivity than the adsorbent coated thereon. This embodiment advantageously provides for adsorption of two different gases to occur simultaneously; one by the coated adsorbent, and one by the substrate. For example, in a stream containing H₂ and undesired CO and CO₂, an adsorbent selective for CO and hydrocarbons having at least one site of unsaturation (an olefin-selective adsorbent) may be coated onto an activated carbon substrate in sheet form. The CO is adsorbed by the olefin-selective adsorbent while the CO₂ may be adsorbed by the activated carbon substrate. Allowing the two gases to be adsorbed simultaneously may improve the flexibility of design for an adsorption bed structure, providing an alternative to bed design requiring adsorption of principally one gas component in a given section of the adsorbent bed structure.

In a further aspect of the invention, a substrate having a microporous structure may be modified to change its adsorption characteristics as well. It has been documented that salts or oxides may be dispersed onto solid supports using thermal dispersion; a process whereby the two components are heated together to a critical temperature which causes the salt or oxide to distribute itself over the surface of the support. By inventive adaptation of such a thermal dispersion technique, a high density, olefin-selective adsorbent sheet according to the invention may be prepared by coating a cloth, felt, or weave containing fibers having a microporous structure upon which a salt or oxide has been dispersed with an olefin-selective adsorbent having the same or different composition as that of the substrate.

The high density adsorbent structures according to the invention may be used in non-PSA applications where physical or chemical adsorption through a low pressure-drop structure is advantageous. High density sheets may be assembled into structures suitable for temperature and/or partial pressure swing adsorption of various gases. An exemplary TSA application utilizes adsorbents for the reversible adsorption of water and/or CO₂. The high density adsorbent sheet structures of the invention would benefit such TSA systems by increasing the bulk density of the adsorbent and subsequently decreasing the size of the adsorbers, and hence the overall unit. Similarly, for applications using PPSA or displacement purge adsorption processes, the size of the adsorbers and overall unit may be advantageously decreased by utilizing the high density adsorbent structures according to the present invention, which have increased bulk density of the adsorbent material relative to previously existing structures.

High density adsorbent sheet structures according to the present invention also may be used in enthalpy devices, conventional examples of which are known in the art, for exchanging sensible and latent heats between gas streams. Smaller and more efficient devices are possible by using the inventive high density sheet structures due to the increased adsorbent loading of the inventive structures compared to existing structures, while such inventive structures still advantageously provide low pressure drop characteristics of existing parallel passage contactor structures. Enthalpy devices may particularly benefit from the modification of the heat capacity characteristics of the high density adsorbent sheet or sheets according to the present invention, as such modifications may improve heat exchange during the adsorption process, and allow the enthalpy device to function with a greater heat transfer efficiency.

High density adsorbent sheets according to an embodiment of the present invention may be fabricated containing adsorbent materials suitable to act as chemical “getters” i.e., materials which chemically sequester target species. Unlike PSA or TSA applications, such adsorbents tend to require chemical regeneration rather than strictly pressure or thermal regeneration. Benefits of incorporating such “getter” type adsorbents into high-density sheet structures according to the present invention include similar benefits to those such inventive high density adsorbent structures bring to PSA and TSA applications; namely improved adsorptive removal of target species as a function of the length of the bed due to the increased adsorbent density of the structure, coupled with the low pressure drop configuration of the parallel passage sheet structure that eliminates fluidization of the adsorbent material.

High density sheet structures according to the invention may be particularly suited to applications where the velocity of the incoming gas stream may exceed the fluidization limits of a traditional packed bed of beaded or extruded adsorbent materials. In high density sheet structures fluidization can be eliminated because the adsorbent particles (effectively the adsorbent sheet(s)) are rigidly held in place within the parallel passage bed structure.

A high density adsorbent sheet according to the invention also may be formed by filling in a section of an adsorbent foam material, and more particularly a zeolite foam material, with a slurry containing an adsorbent material which has the same or different composition as that comprising the foam framework.

Conversion of Binder Materials

When adsorbent powders are coated onto substrates, a binder system is generally a necessary addition to the adsorbent slurry mixture to provide an inter-particle network of bridges, which adhere the adsorbent particles to each other and to the substrate. The binder may be added concurrently with the adsorbent powder or subsequent to the coating process. It may be desirable to disperse the binder within the adsorbent slurry to maximize the dispersion of the binder within the resulting coated adsorbent sheet. Using adsorbent slurries lacking a binder typically produces sheets that are undesirably prone to high dust production and low strength, and therefore are undesirable or unsuitable for use in many adsorption processes, particularly in PSA and rapid cycle PSA.

Binder systems comprising clay mineral materials are a typical binder system useful for producing conventional beaded or pellet adsorbents. Several types of clays are known for use as bindering agents, including, but not limited to, kaolin, attapulgite, bentonite, and mixtures of such materials. When kaolin is heated to temperatures of about 550-600° C., the kaolin clay material undergoes a transformation from kaolin to metakaolin. Metakaolin may be converted to several different zeolite materials depending on the balance of the reagents in a supplied reacting medium. Zeolites A, X, Y and LSX, which are known to be useful for adsorption purposes, all may be synthesized from metakaolin. The chemistry behind such conversions is known and is the route taken by manufacturers of adsorbent beads and pellets to produce high adsorbent density beads and pellets. For example, catalyst particles for fluidized catalytic cracking (FCC) systems are prepared by converting metakaolin spherules into zeolite.

High density adsorbent sheets according to the present invention may be fabricated that comprise kaolin or metakaolin. The use of kaolin to fabricate high density adsorbent sheets according to disclosed embodiments of the present invention is facilitated because individual kaolin particles bond together during the firing process to metakaolin and provide additional strength to the adsorbent sheet. This is advantageous for manipulating the sheets and constructing suitable parallel passage adsorber structures. The conversion of metakaolin to zeolite is influenced, but does not depend on, the presence of zeolite adsorbent materials. As a result, in the present inventive embodiments, the amount of clay material present in the sheets prior to conversion as a percent of the total solids in the sheet may be anywhere between greater than zero weight percent, e.g. between 1 and 100 weight percent. In some disclosed embodiments of the invention, zeolite adsorbent materials advantageously may be included in the clay sheet, as conversion of the clay to zeolite may take place at milder conditions and/or shorter reaction times in sheets initially comprising some zeolite material prior to conversion, relative to all-clay, pre-conversion sheets. In all configurations of the above inventive embodiments, the resulting converted high density adsorbent sheets achieve an advantageous increased adsorbent density by way of removing at least a portion of the binder material from the system by conversion to active adsorbent material.

According to a disclosed embodiment of the present invention, converting clay material in a precursor sheet structure into active zeolite adsorbent material in a resulting high density adsorbent sheet structure typically uses conditions that maintain sheet integrity. For example, caustic fluid used to convert the clay material is thoroughly mixed to homogenize any temperature and/or concentration gradients within the fluid. Attempts to convert supported and unsupported or self-supported sheets (sheets without a structural substrate material) comprising precursor clay material by suspending the sheet(s) in a stirred reactor vessel generally were unsuccessful as the integrity of the sheets failed. Without being bound to any particular theory, shear forces exerted on the sheets within the stirred reactor vessel during conversion, such as shear forces resulting from the required mixing of the caustic fluid, may have exceeded the strength of the sheets under the given conditions. However, in order to properly mix a reactor vessel containing a caustic liquid suitable for converting clay precursor materials to zeolite materials, such as conversion caustic liquids known in the art, shear mixing forces suitable to achieve turbulent flow of the fluid should be exerted on the caustic fluid. Without turbulent flow within the caustic fluid, heat and concentration gradients are not quickly homogenized as has been found desirable to facilitate the clay-to-zeolite conversion chemistry in the sheet structures of the invention.

In order to successfully convert a precursor clay-containing sheet structure to a high density zeolite adsorbent structure according to disclosed embodiments of the present invention, the sheet(s) may be packaged into a parallel passage structure that allows the caustic fluid to flow parallel to the sheets during conversion. Suitable configurations for the sheet may comprise multi-layered, discrete flat sheet or continuous, spirally wrapped single sheet configurations. It is preferred to package the sheets for the conversion process into a configuration suitable for the desired end use of the resulting high density adsorbent structure or monolith in an adsorption process to minimize subsequent handling and packaging of the converted high density adsorbent sheets. In a preferred example of the disclosed embodiments, the precursor sheet comprising clay material are wound in a continuous spiral around a central mandrel means incorporating a suitable spacer means to space adjacent concentric layers of the sheet from each other. The spiral structure is subjected to conversion by flowing a suitable caustic conversion fluid through the spiral structure, such that the resulting high density, spirally wound adsorbent structure may be configured for use as a preferred parallel passage adsorbent bed in an adsorption process, such as rapid cycle PSA. Caustic fluids generally found suitable for use in the processes described herein typically comprise a suitable silicate material and a base. More particularly, caustic fluids have been used that comprise sodium silicate, and a mixture of potassium hydroxide and sodium hydroxide (typically in about a 3:1 ratio), the base having a molarity of about 15-20M.

As in the embodiment of the invention described above, a precursor, clay-containing sheet may be packaged into a structure comprising a plurality of parallel flow channels between the layers of the sheet or sheets. A suitable caustic fluid may be passed though the structure to convert the clay material to zeolite adsorbent, while maintaining the integrity of the resulting high density adsorbent sheet(s). In such a structure configured for sheet conversion according to the invention, a continuous flow of the caustic fluid through the flow channels between the sheet layers minimizes thermal and concentration gradients in the fluid. By configuring a parallel passage conversion sheet structure using an appropriate flow channel height (determined by the height of the spacer or spacer means used to space apart adjacent sheet layers in the conversion structure; spacer heights typically range from 75 μm to about 1,000 μm, with this upper range being primarily suitable for catalysis, and for adsorbent processes spacer heights typically range from about 75 μm to about 400 μm, and even more typically from about 200 μm to about 300 μm), it may be possible to approximate a laminar flow of the caustic fluid through the flow channels in the conversion structure. Such laminar flow within the inventive conversion structure advantageously reduces the shear stresses exerted on the sheets during the conversion process, and thereby reduces any negative effect on the integrity of the resulting high density adsorbent sheets.

The spacing means used to provide a flow channel in the high density parallel passage adsorbent structures according to the present invention (and also the precursor conversion structures prior to conversion) may comprise any suitable spacer structure known in the art or hereafter developed for spacing apart adjacent sheet layers in a parallel passage contactor type structure. Such suitable spacer structures may comprise, without limitation, discrete cylindrical (or other geometrically shaped) spacer structures printed or deposited on the sheet, or extruded or embossed as part of the sheet during fabrication. Such discrete spacer structures may be regularly spaced across the sheet surface as described in the art for use in parallel passage sheet structures, such as adsorbent bed structures. A preferred such discrete spacer structure may comprise the same adsorbent material as is present in the adsorbent sheet utilized in the adsorbent structure, which may be selected according to the intended adsorptive separation application of the high density adsorbent structure. At least a portion of the desired adsorbent material in such spacer structures may comprise adsorbent material converted from a precursor material during the sheet conversion process. In the resulting converted high density adsorbent structure comprising such converted spacers, the overall adsorbent density of the adsorbent structure is advantageously increased by having the spacer material comprised of active adsorbent material for contribution to the intended adsorptive separation application. For a clay-containing sheet structure which is to undergo a conversion process to become a high density adsorbent structure according to the invention, a preferred spacer may comprise clay and/or a clay/zeolite mixture. The spacer itself therefore may be converted to active zeolite adsorbent during the sheet conversion process, thereby contributing to the overall adsorbent density in the resulting high density adsorbent structure for use as a high density adsorber element for a desired adsorption process. Zeolite-based slurries containing a zeolite and a colloidal suspension of, for example, silica, alumina, ceria, zirconia, yttria, and combinations thereof, also may be used as spacer material. In the case of an exemplary inventive high density adsorbent structure comprising activated carbon sheets, an advantageous spacer may comprise activated carbon adsorbent material.

Suitable spacer structures also may comprise metallic mesh, web, foil, wire, expanded metal, and combinations thereof. Stainless steel wire mesh has been successfully demonstrated for use in high density adsorbent structures according to the invention. Suitable metallic spacer materials are not limited to stainless steel and may include other known metallic materials; however, the selected material preferably is compatible with intended conversion process conditions for use in specific inventive adsorbent structures, such as highly caustic solutions at temperatures between 25 and 250° C. in the case of adsorbent structures undergoing clay conversion to zeolite adsorbents. Preferred spacer materials also may be stable to temperatures greater than about 250° C. so that the converted high density adsorbent sheet structures comprising the spacer may heated to remove water within the zeolite and activate the structure to permit gas adsorption in an adsorptive cycle, such as a PSA or rapid cycle PSA cycle. Typical activation temperatures range between about 250 to 650° C. A suitable method of activation including gas composition, flow rate, heating rates, maximum temperature, and any isothermal dwell periods may be selected according to the activation characteristics of the specific adsorbent material involved. For example, in an embodiment of the present invention comprising zeolite 13X (NaX) adsorbent material, an activation sequence that reaches 350° C. typically may be required to activate the adsorbent for gas separation. In another exemplary embodiment, CaX zeolite may require a higher activation temperature (in excess of 450° C.) to fully dry the zeolite for it to be active for gas adsorption. Notwithstanding, lower than typical activation temperatures may be used for any given adsorbent material, resulting in a diminished capacity of the adsorbent for a selected gas.

Processing Conditions

For application to embodiments of the present invention as described herein, a variety of zeolites and related microporous materials suitable for adsorption applications may be synthesized using chemical conversion techniques known in the art. Among these, Zeolite A, X, Y, LSX, and chabazite may be synthesized by known techniques for chemically converting clay precursor materials by modifying the chemistry and conversion conditions within known parameters. Zeolites also can be synthesized using an alumina-based precursor material by making the appropriate changes to the solution chemistry for an alumina-based system, as per the art. Titanosilicate molecular sieves can be prepared via chemical conversion using a titania-based precursor material. Potentially other precursor material-to-adsorbent conversion techniques may be applied to the structures of the present invention to result in the inventive high density adsorbent sheet structures.

Further processing in addition to the above-described conversion processes may be performed to the inventive adsorbent sheets while configured in the described structural configurations, such as parallel channel structural configurations. Ion exchange in zeolite materials is known for use in conventional beaded adsorbent materials to alter the adsorption characteristics of a specific zeolite type. The ions contained in zeolite materials within the inventive high density adsorbent sheet structures can be exchanged by flowing a solution containing a desired salt through the structure. The salt used is determined by considering salts whose ions are soluble in water and have a hydrated ionic radius of a size that allows them to enter the zeolite structure. Many of the elements in the periodic table have been successfully exchanged into zeolites. Ions commonly exchanged into zeolites include, but are not limited to, Na³⁰ , K³⁰ , Ca²⁺, Li³⁰ , Cu²⁺, and Ba²⁺, and Ag³⁰ and NH₄⁺. Zeolites contained in adsorbent sheets made according to the invention may be ion exchanged with ions present in a salt solution by flowing such salt solution containing the desired exchangeable ions through the inventive high density adsorbent sheet structure.

Self-Supporting Adsorbent Sheets

Converting binder material to active adsorbent according to an aspect of the present invention is a productive route to producing high density adsorbent sheets. It also is possible to increase the density of an adsorbent sheet by excluding inert support materials, which do not contribute to the desired end-use adsorptive process for the sheet or by using support materials which comprise active adsorbent materials themselves.

A common issue when dealing with casting a ceramic film is the drying behaviour of the mixture containing the powder (herein defined as a slurry). If the drying behaviour of the slurry is not appropriate, the film may crack or curl, making it impossible to package the film or sheet into an adsorber element suitable for desired adsorption processes, such as rapid-cycle PSA. It has proven difficult to produce a tape cast sheet in its “green” form, i.e. form prior to conversion, which may be heated to a temperature sufficient to decompose binder materials. A green sheet or film which is elastic enough to resist cutting and bending without losing integrity is highly desirable because it allows for a greater number of packaging options for packaging the sheet or film into parallel passage adsorber structures including spirally wound geometries. Rigid or fragile sheets are more difficult to package and may be suitable only for lamellar geometries, if they are useable at all.

In order to fabricate self-supporting adsorbent sheets according to the present invention that do not include any distinct inert support or substrate material, slurry additives are desirable to impart specific characteristics to the sheet. Suitable slurry additives may be selected to impart, for example, a desirable degree of sheet elasticity, such that a high degree of sheet flatness may be maintained without cracking. Handling and packaging the sheet, such as into spiral wound configurations according to an embodiment of the invention, are therefore possible. Suitable additives to create slurries suitable for casting or forming adsorbent sheets for use in the high density adsorbent structures of the present invention, which are substantially free of support or substrate material, may comprise for example, and without limitation, latexes, silicones, butyrates, similar rubberizing and/or plasticizing agents known in the art, and combinations thereof. Such additives may be used to impart a degree of elasticity to the adsorbent sheet and allow the sheet to be bent and flexed without fragmenting or cracking.

An active adsorbent material for use in the inventive high density adsorbent structures may require activation at a temperature lower than the decomposition temperature of any additive materials present in the adsorbent sheet slurry. As a result, a separate binder additive, such as clay material, may not be required to bind the adsorbent particles together following activation, since the plasticizing and/or rubberizing slurry matrix may suitably act to hold the adsorbent particles together. However, when a target adsorbent material requires an activation step above the thermal stability of the slurry additive(s), a separate binder material may be required to maintain a binding network between the adsorbent particles once the organic portion of the slurry has decomposed. In such situations, clay or colloidal material dispersions, such as those comprising, for example, silica, zirconia, yttria, or mixtures thereof, may be used advantageously to provide a particle binding network (which is stable to the elevated activation temperatures) within an organic slurry additive matrix. Silicones may act similarly to latexes to rubberize the sheet while having the additional benefit of depositing a residual silica binder network if the sheet is fired at temperatures above the decomposition temperature of the silicone. The temperature at which the sheet is activated generally is dictated by the selected adsorbent and the adsorptive process in which it may be used. Temperatures as low as about 15° C. and as high as about 650° C. may be used to activate adsorbent materials.

The adsorbent used in the slurry to form a self-supporting sheet substantially without inert support or substrate material for use according to the invention may be chosen from any suitable adsorbent materials for a desired adsorptive application, such as those comprising zeolites, activated carbons (with or without an internal micropore structure), carbon molecular sieves, aluminas, silicas, titanosilicate molecular sieves, or combinations thereof. Clay and titania, while not considered to be adsorbents for gas separation, also may be used in the adsorbent material slurry in any ratio an amount greater than 0%, e.g. between 1% and 100%, of the total solids present because the resulting inventive high density adsorbent sheet structure subsequently may be converted to active adsorbent using chemical conversion steps, such as are described herein.

Substantially support or substrate-free adsorbent sheets suitable for use in the present invention may be fabricated using any appropriate coating method. Tape casting, a common coating method used in the ceramics industry, may be used to extrude adsorbent slurries into sheets. Nip rolling is another coating technique exemplified by compressing the slurry between two sheets of non-adsorbent material set between rollers a defined distance apart. The distance between the rollers determines the sheet thickness. Appropriate sheet thicknesses may be selected depending on the intended adsorptive application, such as is previously described in the art.

Advantageously, the casting or forming process allows extruded features to be added to the support or substrate-free adsorbent sheets. By forming or casting the slurry over an impermeable material (such as a plastic) that has been embossed, etched, or stamped with a pattern produces sheets that can have an integral pattern of pillars or ridges. Once assembled into an adsorber element, such as by stacking sheets, or spirally winding an adsorbent sheet, this integral pattern of extruded material may act as a spacer between the sheets to form a high density parallel passage adsorbent structure according to the invention. This configuration further provides for a high adsorbent density for the bed because the spacers also contain active adsorbent or can be converted to active adsorbent.

Activating the self-supporting sheets may be performed in several ways depending on the adsorbent selected and the intended application of the adsorbent structure comprising the sheet. When it is necessary to activate the sheet to temperatures above the decomposition temperature of any organic additive, care may be taken to avoid combustion. Combustion may produce a rapid local temperature rise in the sheet which can damage the adsorbent if the tolerance of the adsorbent is exceeded.

Preferably, the substantially self-supported sheets may be packaged into a parallel channel high density adsorbent structure according to a preferred embodiment of the invention, suitable for a selected adsorption process such as a PSA cycle. Such inventive adsorbent structures may be activated prior to adsorptive use according to a suitable procedure for the adsorbents involved, such as is known in the art. It has been found that a two-step activation sequence may be desirable. An exemplary two-step process involves passing an activation gas through the inventive structure parallel to the adsorbent sheets. The first stage of the activation may be completed in a non-oxidizing atmosphere, such as N₂, Ar, or CO₂, to pyrolyze any organic material present in the self-supporting adsorbent sheets. The pyrolysis step may remove a significant portion of the organic material, and may desirably prevent ignition of the organic material. Subsequent to the pyrolysis step, a polishing step may be conducted by passing an oxidizing gas, such as air, through the adsorbent structure. This removes remaining carbonaceous material, which may reduce the likelihood that carbon deposition within the pore structure of the adsorbent inhibits the performance of the adsorbent structure.

Addition of Non-Supporting Components to Self-Supporting Sheets

It may be desirable to modify some of the physical properties of the self-supporting sheets described above for application to the high density adsorbent structures of the present invention by introducing other materials. The heat capacity and conductivity of a self-supporting adsorbent sheet may be modified by including a material possessing a desired thermal conductivity, such as a metallic material. Any metallic or other material possessing suitable thermal properties may be added to the self-supported adsorbent sheet provided it is suited to the chemical conditions within the slurry mixture and the appropriate activation cycle. The metallic or other material may be introduced, for example, as strands, wires, chopped fibers or ribbons. The amount of added thermal material may be selected to be sufficient to impart desired heat capacity and heat conductivity characteristics to the adsorbent sheet, but does not need to provide support to the sheet, as the adsorbent sheet is self-supporting. Altering the intrinsic heat transfer characteristics of self-supported adsorbent sheets may be beneficial to selected adsorption processes, such as PSA, because thermal gradients within the adsorbent sheet structure may be controlled. Operating the adsorber element under controlled thermal conditions, such as isothermal conditions, may result in better performance of the self-supported adsorbent structure in a selected adsorption cycle. Inventive adsorbent structures comprising self-supporting adsorbent sheets including additions of thermal property altering materials may advantageously provide increased adsorbent density relative to known structures. This is because the amount of thermal material required within the self-supported sheet to enable control of thermal properties of the sheet generally may be much less than the amount of support and/or substrate materials present in a non-self-supported sheet structure as known in the art. The distribution of the thermal property material in the sheet may be uniform or may be isolated to specific areas of the sheet. This characteristic allows the thermal characteristics of the inventive, self-supported sheet structure to be precisely tailored to a desired adsorptive application.

Catalyst Support Structures

Self-supporting sheet structures formed by an arrangement of self-supported sheet(s) and discrete or continuous spacer material according to aspects of the present invention may be used as catalyst support structures. The catalyst material may be intrinsic to the sheet(s) in the structure or may be added in a secondary fashion to the sheet(s) or structure.

Typical known catalyst supports, such as cordierite honeycombs, are extruded, self-supporting structures with a plurality of parallel channels. The void space ratio in such known structures cannot easily be varied by independently varying the wall thickness and the channel width, nor can a catalyst material be easily applied to the inner surfaces and walls of such a structure in a controllable and uniform manner.

The surface area of self-supported parallel passage sheet structures according to the present invention based on multiple layers of thin sheets or films separated by a thin spacer or spacer means may be up to twice or more compared to currently known honeycomb structures having the highest surface area available. The higher surface area of the self-supported parallel passage sheet structures of the present invention may provide greater gas contact with the sheet(s) as a function of the length of the structure. In a catalyst system, greater gas contact may provide improve the performance of the catalyst bed by achieving a higher level of conversion of the reactants as a function of the bed length.

When it is desirable to add a film of material to the walls of a conventional honeycomb catalyst support, wash-coating a desired catalytic material onto the structure is a commonly known method of deposition. Materials for washcoating, typically called carriers, generally comprise high-surface-area inorganic solids having an intrinsic micropore structure. Examples of such materials include zeolites, such as zeolite Y, mordenite, ZSM-5, ZSM-11, or similar zeolites with high thermal stability, alumina, silica, ceria, titania, vanadia, and combinations of these materials. To complete the fabrication of a conventional honeycomb catalyst bed, a catalytically active material subsequently may be added to the carrier, typically by impregnation using a fluid carrier. Catalyst compositions may be tailored for the end use of the catalyst structure and may generally be proprietary in composition. Typical materials impregnated into catalyst structures may comprise, but are not limited to, Pt, Au, Rh, and Pd, Fe, Co, Ni, Cu, and combinations thereof.

Washcoating narrow flow channels with a width to height ratio of less than 2, such as those on known honeycomb catalyst supports, with a slurry containing a carrier or carriers dispersed in a fluid frequently results in an uneven coating thickness on the walls of the channel. This is thought to be due to the surface tension of the slurry within the channel, which tends to deposit a greater amount of material in the comers of the channel and a lesser amount on the walls. This situation may be somewhat moderated, but not eliminated, by altering the channel geometry to more cylindrical configurations. Practical limits for washcoating material onto the walls of the channels in a conventional honeycomb structure may be reached when the structures have a high cells per square inch (cpsi) count; a design where the flow channels have very narrow openings. Problems with impregnating the channels typically increase with decreasing channel width because the surface tension of the carrier slurry prevents the slurry from easily penetrating the channels and capillary effects within the filled channel make removing excess carrier from the structure problematic.

Non-uniform coating thickness of a carrier fluid on the walls of the channels of conventional honeycomb structures may negatively affect the activity of the catalyst structure. When the active catalyst material is subsequently impregnated into the carrier fluid, a substantial amount of active materials may be sequestered in thicker portions of the carrier coating. The catalyst materials contained in the thicker portion of the coating are less accessible to a gas stream passing through the conventional structure than the material present on the thinner coating on the walls of the channel. Such limitations of typical conventional catalyst structures are undesirable because they decrease the effectiveness of the structure, which may use costly materials, such as precious metals. Furthermore, the carrier impregnation process does not typically result in a very high degree of dispersion of the catalyst material on the carrier. The carrier may not capture equivalent amounts of material-containing fluid, which may produce areas of high and low catalyst material loading. Areas of high material loading may sinter at typical high operating temperatures, which reduces the efficiency of that region of catalyst and reduces the overall performance of the catalyst structure.

When self-supporting sheets are used to assemble a parallel passage structure according to the present invention, inhomogeneities from washcoating may be desirably reduced, due to the flow channels of the inventive structures, which typically have a width-to-height ratio significantly greater than 2 and preferably greater than about 25. Such ratio is much greater than the average honeycomb structure, which may have an equivalent channel aspect ratio of unity. The favorable flow channel aspect ratio of a parallel channel structure formed from a self-supporting sheet or sheets according to the present invention may allow for a much narrower channel to be filled and emptied than in the case of conventional honeycomb structures. This is because capillary effects diminish with channels that are much wider than their height.

A sheet structure according to the present invention may be assembled including a sheet containing the desired carrier material for catalytic use. The amount and type of a carrier in the sheet may be dictated by the desired end use of the inventive catalytic structure and may comprise anywhere from greater than zero %, e.g. 1% to 100%, of the weight of the solids in the sheet. The balance of the sheet may comprise another carrier material or a clay. Such a self-supported sheet may be further treated by washcoating using any suitable method, including dip coating, or combination of suitable methods, to deposit a carrier film onto one or both sides of the sheet(s). The film of carrier material deposited on the sheet(s) may be of the same or different composition compared to the composition of the sheet. Highly uniform coatings can be achieved using this method because capillary effects are absent until the sheet(s) are assembled into the inventive parallel channel structure.

The catalyst impregnation of a sheet including a carrier material may be done before or after the sheet is assembled into the inventive parallel channel structure. To impregnate the catalyst metal or metals onto the carrier, the sheet may be exposed to one or a series of tanks containing the catalyst solution(s) to be impregnated. Alternatively, the carrier sheet may be impregnated by spraying or printing the catalyst solution(s) onto the sheet. Having access to the internal surface of the catalyst bed allows the catalyst metal(s) to be precisely placed to maximize their dispersion and minimize potential sintering effects. Major cost reductions may be realized using such impregnation methods, particularly printing methods, because much less active metal catalyst is used to produce a catalyst bed having the same activity toward a selected reaction. Further advantages can be realized by printing different types of catalyst materials in discrete sections of the sheet(s). The sheet(s) can then be assembled into a high-density, parallel-passage, catalyst structure according to the present invention having regions of different catalytic activity throughout the length. This configuration also could be achieved by combining a series of beds, each containing a single target catalyst

In the case of a sheet including a zeolite carrier, an ion exchange step to incorporate catalytically active compounds, such as metals, into the zeolite structure also may be carried out using the same, or similar, methods. If the sheet including a carrier is assembled into a parallel channel sheet structure, the catalyst fluid may be flowed through the channels to wet the carrier.

Conventional honeycomb supports presently in use as catalyst supports generally comprise inorganic (cordierite) or metallic materials. Metal honeycombs have superior heat transfer characteristics but the thermal expansion characteristics of the metal are significantly different than the coatings typically used. This may cause significant adhesion problems of the carrier to the metal support. In many instances, the carrier cannot be adequately adhered to the metal support to withstand repeated thermal cycling. The benefits of coating and impregnating self-supporting sheet structures can be coupled with the benefits of metal honeycombs by using sheets containing materials having desired heat transfer properties in the various aforementioned configurations. The carrier in this case adheres to an inorganic base while the material added to enhance heat transfer characteristics of the sheet may impart the desired thermal properties of a conventional metal support structure.

Combinations

Some adsorbent materials exist that may not be easily amenable to forming into high density adsorbent structures. This situation may arise due to specially required synthesis conditions of the adsorbent or incompatibility issues with a conversion process. A selected adsorbent material also may need to be matched with a specific support or substrate to impart preferred heat transfer, adsorptive, or surface texture characteristics to the sheet including that adsorbent. Further, not all adsorbent or catalyst carrier materials may be easily amenable to produce self-supporting sheets with durability suitable for all applications. Furthermore, not all adsorptive or catalytic processes may benefit substantially from high density structures if mass transfer considerations require only a thin surface coat. In such cases, and when more than one adsorbent is required in the bed, it may be preferable to mix, blend, interleave, or stack high density adsorbent sheets according to the above disclosed embodiments of the present invention together with the inert material supported adsorbent sheet(s) disclosed in the art.

A synergistic approach to adsorbent selection may be possible when an adsorptive separation process requires regions of the adsorber structure to have different characteristics depending on the adsorption or reaction rate. In such cases, utilizing the benefits of high density adsorbent structures only where beneficial may serve to increase the performance of the entire process. This allows tuning each section of the adsorber structure to a specific adsorption or catalytic process.

It will be apparent to those of ordinary skill in the art that the present invention may be modified in arrangement and detail without departing from the principles disclosed above.

1. A high density adsorbent sheet comprising at least one support material and at least one first active adsorbent material applied to said support material, the support material comprising at least one second active adsorbent material.

2. The high density adsorbent sheet according to claim 1 wherein the first active adsorbent material is the same as the second active adsorbent material.

3. The high density adsorbent sheet according to claim 2 wherein the first and second active adsorbent materials comprise activated carbon.

4. A high density parallel passage adsorbent structure comprising:
at least one high density adsorbent sheet comprising at least one support material and at least one first active adsorbent material applied to said support material, the support material comprising at least one second active adsorbent material; and
at least one spacing means situated adjacent to said high density adsorbent sheet to substantially define a gas flow channel.

5. The high density parallel passage adsorbent structure according to claim 4 wherein the adsorbent structure is configured as a spiral adsorbent structure wound around a central mandrel means.

6. A high density adsorbent sheet comprising at least one support material and at least one precursor adsorbent material applied to said support material wherein the precursor adsorbent material has been substantially converted to at least one active adsorbent material after being applied to the support by contacting with a caustic conversion fluid.

7. The high density adsorbent sheet according to claim 6 wherein the at least one precursor adsorbent material comprises kaolin, titania, ceria, or combinations thereof.

8. The high density adsorbent sheet according to claim 6 wherein the at least one active adsorbent material comprises a zeolite adsorbent.

9. The high density adsorbent sheet according to claim 8 wherein the zeolite adsorbent comprises A zeolite, Y zeolite, X zeolite, LSX zeolite, or combinations thereof.

10. A high density parallel passage adsorbent structure, comprising;
at least one high density adsorbent sheet comprising at least one support material and at least one precursor adsorbent material applied to said support material wherein the precursor adsorbent material has been substantially converted to at least one active adsorbent material after being applied to the support by contacting with a caustic conversion fluid; and
at least one spacing means situated adjacent to said high density adsorbent sheet to substantially define a gas flow channel.

11. The high density parallel passage adsorbent structure according to claim 10 wherein the adsorbent structure is configured as a spiral adsorbent structure wound around a central mandrel means.

12. A self-supported high density adsorbent sheet, substantially free of inert support material, comprising at least one precursor adsorbent material wherein the precursor adsorbent material has been substantially converted to at least one active adsorbent material by contacting with a caustic conversion fluid.

13. The self-supported high density adsorbent sheet according to claim 12 wherein the at least one precursor adsorbent material comprises kaolin, titania, ceria, or combinations thereof.

14. The self-supported high density adsorbent sheet according to claim 12 wherein the at least one active adsorbent material comprises a zeolite adsorbent.

15. The high density adsorbent sheet according to claim 14 wherein the zeolite adsorbent comprises A zeolite, Y zeolite, X zeolite, LSX zeolite, or combinations thereof.

16. A self-supported high density parallel passage adsorbent structure, comprising:
at least one self-supported high density adsorbent sheet, substantially free of inert support material, comprising at least one precursor adsorbent material wherein the precursor adsorbent material has been substantially converted to at least one active adsorbent material by contacting with a caustic conversion fluid; and
at least one spacing means situated adjacent to said self-supported high density adsorbent sheet to substantially define a gas flow channel.

17. The self-supported high density parallel passage adsorbent structure according to claim 16 wherein the adsorbent structure is configured as a spiral adsorbent structure wound around a central mandrel means.

18. The self-supported high density adsorbent sheet according to claim 12, additionally comprising at least one thermally conductive material situated within the adsorbent sheet, wherein the at least one thermally conductive material is effective to increase the thermal conductivity of the adsorbent sheet.

19. The self-supported high density adsorbent sheet according to claim 18, wherein the at least one thermally conductive material is a metallic material.

20. The self-supported high density adsorbent sheet according to claim 12, additionally comprising at least one thermally capacitive material situated within the adsorbent sheet, wherein the at least one thermally capacitive material is effective to increase the thermal capacity of the adsorbent sheet.
